(19) United States
(12) Patent Application Publication
(10) Pub. No.: US 2025/0278417 A1
(43) Pub. Date: Sep. 4, 2025

(54) LARGE LANGUAGE MODEL-BASED KNOWLEDGE GRAPHS

(71) Applicant: Salesforce, Inc., San Francisco, CA (US)

(72) Inventors: Phil Mui, San Francisco, CA (US); Ricky Ho, San Francisco, CA (US); Chien-Shen Wu, San Francisco, CA (US); Xiangyu Peng, Palo Alto, CA (US); Max Comparetto, New York, NY (US); Prafulla Kumar Choubey, Palo Alto, CA (US); Clara Shih, San Francisco, CA (US)

(21) Appl. No.: 19/066,056

(22) Filed: Feb. 27, 2025

Related U.S. Application Data
(60) Provisional application No. 63/559,791, filed on Feb. 29, 2024.

(51) Int. Cl. G06F 16/332; G06F 40/30

(52) U.S. Cl. CPC G06F 16/3328; G06F 40/30

(57) ABSTRACT

Methods, apparatuses, and computer program products are disclosed. The method may include receiving a first request to ingest a document. The method may include generating, using a large language model (LLM), a knowledge graph including a plurality of graph triples, each graph triple including a first node, a second node, and an edge connecting the first node and the second node, where each first node corresponds to a first element type of the document, where each second node corresponds to a second element type of the document, and where each edge corresponds to a third element type of the document. The method may include receiving a second request to generate a generative response with the LLM. The method may include presenting a response to the second request, the response generated by the LLM based at least in part on the knowledge graph.

### CROSS REFERENCES

The present Application for Patent claims priority to U.S. Provisional Patent Application No. 63/559,791 by Mui et al., entitled “LARGE LANGUAGE MODEL-BASED KNOWLEDGED GRAPHS,” filed Feb. 29, 2024, assigned to the assignee hereof.

### FIELD OF TECHNOLOGY

The present disclosure relates generally to database systems and data processing, and more specifically to large language model-based knowledge graphs.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In some cloud computing scenarios, large language models (LLMs) may be used to generate responses to client queries. However, such approaches may be improved.

### BRIEF DESCRIPTION OF THE DRAWINGS

FIG. 1 illustrates an example of a data processing system that supports large language model-based knowledge graphs in accordance with examples as disclosed herein.

FIG. 2 shows an example of a system that supports large language model-based knowledge graphs in accordance with examples as disclosed herein.

FIG. 3 shows an example of a knowledge graph that supports large language model-based knowledge graphs in accordance with examples as disclosed herein.

FIG. 4 shows an example of a knowledge graph that supports large language model-based knowledge graphs in accordance with examples as disclosed herein.

FIG. 5 shows an example of a process flow that supports large language model-based knowledge graphs in accordance with examples as disclosed herein.

FIG. 6 shows a block diagram of an apparatus that supports large language model-based knowledge graphs in accordance with examples as disclosed herein.

FIG. 7 shows a block diagram of a knowledge graph manager that supports large language model-based knowledge graphs in accordance with examples as disclosed herein.

FIG. 8 shows a diagram of a system including a device that supports large language model-based knowledge graphs in accordance with examples as disclosed herein.

FIG. 9 shows a flowchart illustrating methods that support large language model-based knowledge graphs in accordance with examples as disclosed herein.

### DETAILED DESCRIPTION

In some cloud computing scenarios, a large language model (LLM) may be employed to generate responses to user queries or to otherwise aid user operations. However, the use of such LLMs involves training of such LLMs on sets of data that include a “knowledge cliff” in that the LLM can only be trained on data that is available at the time of training. As such, other approaches involving the use of LLMs may not allow for responses to queries that involve information or events associated with dates falling after the date of training.

The techniques described herein involve the ingestion of documents (e.g., websites, documents, media, or other information) to generate a knowledge graph that describes the content of the document in an easily-retrievable, information-dense format. For example, a knowledge graph may include graph triples that may indicate nodes and edges of the knowledge graph (e.g., a first node and a second node connected by an edge). The nodes and edges may represent information included in the document in various ways, including as semantic representations (e.g., in a subject-predicate/relationship-object format or organization where a node is a subject, an edge is a predicate or relationship, and another node is an object) or in other ways (e.g., a knowledge graph that describes an entities relationships with various other entities). For example, a system may ingest the document and create the knowledge graph using an LLM to identify categories or classes of information included in the document (e.g., that are to correspond to nodes, edges, or both) and may form the various graph triples (e.g., based on determined relationships between the entities identified in the document). The LLM may then utilize the knowledge graph to include the information stored therein (that ultimately was sourced from the document) in responses to client queries. In some examples, the graph triples used in the knowledge graph may be unconstrained triples, in that the nodes and edges in the knowledge graph are not constrained to categories or classes, and the LLM may determine which categories or classes are to be used in the knowledge graph. In some examples, the graph triples used may be constrained triples, in that a client may provide constraints on the element types, categories, or classes that are to be represented by the nodes and edges, allowing a user to specific which types of information are to be included in the knowledge graph (and ultimately in a response to an LLM query) In this way, the system may allow for an LLM to respond to queries using information that was not available at the time of training (e.g., beyond the “knowledge cliff”) allowing for more up-to-date responses and increased accuracy of responses to LLM queries.

Aspects of the disclosure are initially described in the context of an environment supporting an on-demand database service. Aspects of the disclosure are then described with reference to a system, knowledge graphs, and a process flow. Aspects of the disclosure are further illustrated by and described with reference to apparatus diagrams, system diagrams, and flowcharts that relate to large language model-based knowledge graphs.

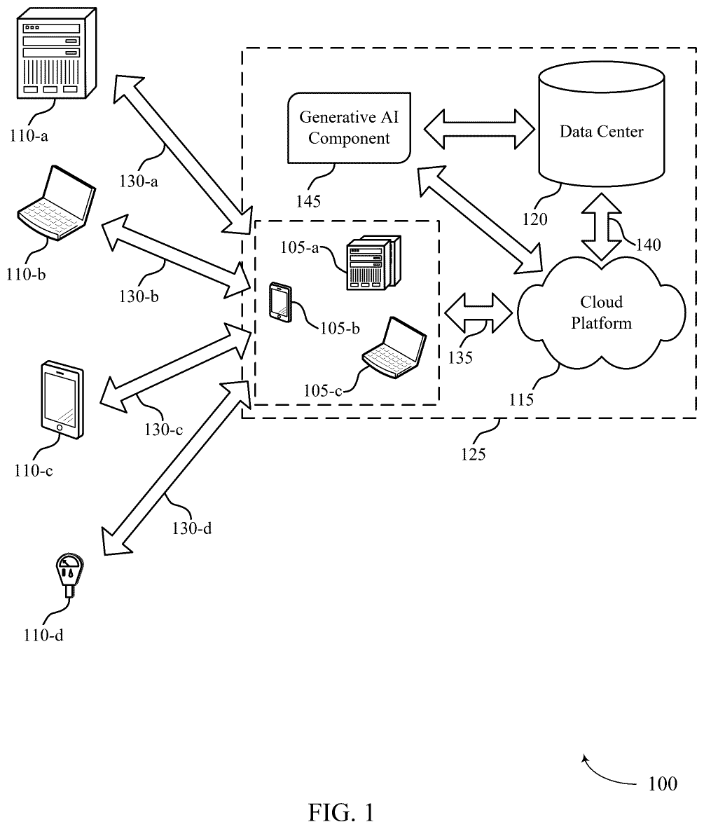

FIG. 1 illustrates an example of a system 100 for cloud computing that supports large language model-based knowledge graphs in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

In some examples, the system 100 may include a generative artificial intelligence (AI) component 145. The generative AI component 145 may be an example or a component of a large language model (LLM), such as a generative AI model. In some examples, the generative AI component 145 may additionally, or alternatively, be referred to as any of an AI, a generative AI (GAI), a GAI model, an LLM, a machine learning model, or any similar terminology. The generative AI component 145 may be a model that is trained on a corpus of input data, which may include text, images, video, audio, structured data, or any combination thereof. Such data may represent general-purpose data, domain-specific data, or any combination thereof. Further, the generative AI component 145 may be supplemented with additional training on data associated with a role, function, or generation outcome to further specialize the generative AI component 145 and increase the accuracy and relevance of information generated with the generative AI component 145.

In some examples, the cloud platform 115 may receive a query from a cloud client 105 that may include a request to produce a response (e.g., text, images, video, audio, or other information) to the query using the generative AI component 145. The cloud platform 115 may input a prompt to the generative AI component 145 that includes, or otherwise indicates, the query (or information included therein). The generative AI component 145 may generate an output (e.g., text, images, video, audio, or other information) that is responsive to the prompt. In some examples, the cloud platform 115 may modify or supplement one or more aspects of the query to increase the quality of the response. In some examples, such modification or supplementation may be referred to as grounding.

The system 100 may support any configuration for the use of generative AI models. In FIG. 1, the generative AI component 145 is depicted as being located external to the subsystem 125. However, the generative AI component 145 may be hosted on the cloud platform 115, elsewhere within the subsystem 125, or outside the subsystem 125 (e.g., a publicly-hosted platform). Additionally, or alternatively, multiple generative AI components 145 may be employed to perform one or more of the actions described as being performed by a single generative AI component 145. Further, in some examples, the generative AI component 145 may communicate with one or more other elements, such as a contact 110, the data center 120, one or more other elements, or any combination thereof, to receive additional information (e.g., that may be indicated in the query or the prompt) that is to be considered for performing generative processes.

In various implementations, the models and/or modules described herein (e.g., including, but not limited to, the generative AI component 145) may be classification, predictive, generative, conversational, or another form of AI technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally, or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, one or more input prompts may be provided to the AI technology for the purpose of eliciting particular responses. In various implementations, the input prompts may correspond to the particular field or task to which the AI technology is trained. Additionally, or alternatively, the AI technology may be implemented along with one or more additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

For example, the system 100 may allow for cloud clients 105 to communicate with the cloud platform 115 to request generated responses from the cloud platform 115 using an LLM. The cloud platform 115 may utilize the LLM to ingest one or more documents indicated by a cloud client and create a knowledge graph that organizes and stored information included in the documents in a structured manner that allows the LLM to retrieve the information to generate responses to LLM queries.

In other approaches, LLMs are subject to a “knowledge cliff” in that LLMs are trained at a point in time, and the LLMs of other approaches were not aware of any information that occurs after the point in time at which the LLMs were trained. Thus, significant gaps, inaccuracies, or other errors may occur in responses generated by LLMs that cannot consider information occurring after training.

The techniques described herein allow for ingestion of additional information from documents or other sources into knowledge graphs that may be easily navigated by an LLM to retrieve the information included in the knowledge graph. The knowledge graphs may include graph triples that may include nodes and edges that may indicate entities (e.g., the nodes) and relationship between the entities (e.g., the edges). In some examples, semantic models (e.g., subject-predicate-object or subject-relationship-predicate models) may be used in the graph triples to store the information from the documents. Such knowledge graphs may be provided to LLMs so that the LLMs may retrieve the information from the knowledge graphs to respond to client LLM queries. In at least this way, LLMs may consider additional information not available to other LLMs, increasing accuracy of LLM responses produced using the techniques described herein.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

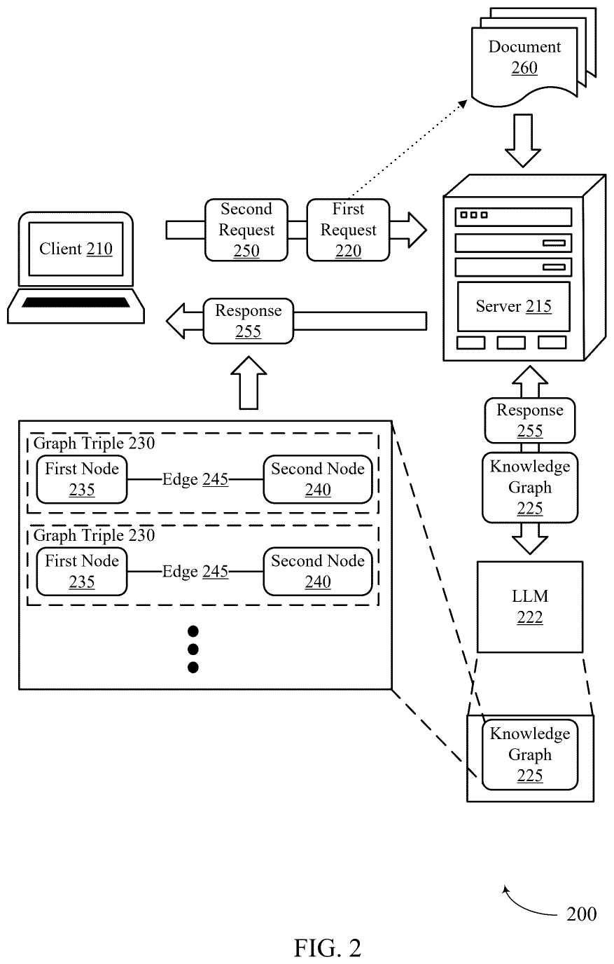

FIG. 2 shows an example of a system 200 that supports large language model-based knowledge graphs in accordance with examples as disclosed herein. The system 200 may include the client 210, the server 215, and the LLM 222, all or any of which may communicate with one another. The client 210, the server 215, and the LLM 222 may be associated with a cloud platform. Though certain techniques or operations may be described as being performed by a client 210, the server 215, or other elements, such techniques or operations may be performed by one or more other elements of a cloud platform or that are associated with such a cloud platform.

In some examples, the server 215 may receive the first request 220 from the client 210. The first request 220 may request that the document 260 (or multiple such documents 260) be ingested into the system 200 (e.g., via the LLM 222) so that the LLM 222 may draw upon the information found within the document 260 to produce the knowledge graph 225, which then may be used to generate responses to LLM queries.

In some examples, the server 215 may obtain the document 260 (or multiple documents 260) to ingest the document 260. In some examples, the document 260 may include any types of content, including text, images, figures, audio, video, or other information that the LLM 222 may extract to create the knowledge graph 225. For example, the document 260 may be an article, a video, an audio recording, a document describing an application programming interface (API), a set of structured data (e.g., included in a database), or other information.

In some examples, the server 215 may pass the document 260 to the LLM 222 for the LLM 222 to generate the knowledge graph 225. For example, the LLM 222 may be trained to analyze documents and infer one or more elements present in the document as well as one or more relationships between elements. The LLM 222 may further package or determine one or more graph triples 230 that may include such recognized or inferred elements and corresponding relationships. For example, a graph triple 230 (also referred to simply as a triple) may include a set of three items or elements, where one of the elements describes a relationship between the other two elements. For example, in some cases, a graph triple 230 may include a first node 235, a second node 240, and an edge 245. In some examples, the first node 235, the second node 240, and the edge 245 may be associated with types or classifications that describe or classify elements of the document 260. In some examples, the first node 235, the second node 240, and the edge 245 may be associated with different element types of the document 260. For example, the first node 235 may be associated with or may indicate a subject of a sentence, the second node 240 may be associated with or may indicate an object of a sentence, and the edge 245 may indicate a relationship or predicate of a sentence (e.g., a relationship or predicate associated with the subject and the object). Though some examples are discussed, here, the first node 235, the second node 240, and the edge 245 may be any information (e.g., entities, relationships, predicates, or other information) that may be determined or inferred from the document 260. In some examples, the first node 235, the second node 240, and the edge 245 may be semantic elements that describe semantic meanings or information that is extracted, determined, or obtained from the document 260.

In some examples, the graph triples 230 may include different element types, structures, nodes, edges, or other elements. In some cases, such different element types may be determined based on the content of the document 260, based on information indicated in the first request 220 (e.g., one or more elements designated by the client 210), or any combination thereof. For example, different document types or content (e.g., writing, pictures, structured data, or other content) may be analyzed by the LLM 222 and may result in different element types or structures being used in the graph triples 230. In some examples, some graph triples 230 may share a first node 235, and such a first node 235 may be referred to as a central node, as multiple edges 245 may be connected or associated with such a first node 235 (as well as to individual second nodes 240 that may be different from one another). In some examples, some graph triples 230 may share a second node 240, in which case multiple first nodes 235 may each be related to the same second node 240 through respective edges 245 (e.g., which may describe the same or different relationships of the respective first nodes 235 with the shared second node 240).

In some examples, the graph triples 230 may be unconstrained triples. Unconstrained triples may be triples in which a role, type, or classification of an element of the triple may not be fixed. For example, the first node 235 of some triples may be a subject of a sentence, whereas in other triples, the first node 235 may be a different element (e.g., an action, relationship, or predicate). Such flexible graph triples 230 may be useful for grounding or training the LLM 222 for different tasks or requests, or for search applications. The use of unconstrained triples may result in larger or more varied knowledge graphs 225 (e.g., as compared to a knowledge graph 225 that includes unconstrained triples). In some examples, such knowledge graphs 225 may include multiple “central” nodes (e.g., multiple instances of sharing of first nodes 235 between graph triples 230 may occur).

In some examples, the graph triples 230 may be constrained triples. Constrained triples may be triples in which a role, type, or classification of an element of the triple may be fixed. Such elements (e.g., the first node 235, the second node 240, and the edge 245) may each be of a particular class or category. Such classes or categories may be requested or indicated in the first request 220, the second request 250, or both. In this way, the client 210 may request information that is constrained by one or more input parameters (e.g., constraint parameters) that indicate one or more classes or categories of information that is requested and such classes or categories may apply to the first node 235, the second node 240, and the edge 245 of such graph triples 230 that are created and used as at least a partial basis for generating the response 255. In some examples, the use of such constrained triples may result in a sparser knowledge graph 225 (e.g., as compared to a knowledge graph 225 that includes unconstrained triples). In some examples, the use of such constrained triples may result fewer common first nodes 235 between graph triples 230 or even a single first node 235 between graph triples 230. In some examples, the LLM 222 may identify information, relationships, entities, or other information expressed in the document 260 that may not correspond with the indicated or constrained classes, categories, or types indicated by the client (or otherwise made available to the server 215). In such cases, the LLM 222 may create or designate another class, category, or element type that may be a default, “catch-all,” or “other” category of information that may be made available to the client 210 in the response 255 or may not be presented to the client 210 in the response 255.

In some examples, the server 215 may receive the second request 250 from the client 210. The second request 250 may include a request for the LLM 222 to generate a response 255 (e.g., a generative response). In response to the second request 250, the server 215 may transmit the second request 250 or information included therein to the LLM 222 for the LLM 222 to process and produce the response 255. In some examples, the LLM 222 may generate the response 255 using the knowledge graph 225. For example, after ingesting the document 260, the knowledge graph 225 and the graph triples 230 therein may be available to the LLM 222 to be used for generating the response. In some examples, the LLM 222 may receive additional training based on the knowledge graph 225 to refine or otherwise modify the LLM 222. Additionally, or alternatively, the LLM 222 may access the knowledge graph to determine one or more graph triples 230 that may include or indicate information that the LLM 222 determines to be relevant to responding to the second request 250.

For example, the LLM 222 may determine that multiple graph triples 230 are relevant to the response 255 and that the information indicated therein is to be included, indicated, or otherwise used to generate the response 255. For example, individual sentences or other output included in the response may be associated with individual graph triples 230 of the knowledge graph 225. In some examples, the system 200 (e.g., using the server 215) may log or map such associations or relationships between portions of the response 255 and graph triples 230 so that the system 200 may provide indications of such logging or mapping (e.g., to analyze or verify the response 255).

In some examples, the LLM 222 may pass the response 255 (or information to be included in the response) to the server 215, and the server 215 may pass the response 255 to the client 210. In some examples, the server 215 may augment or format the response for presentation to the client 210. In some examples, the response 255 may include a list of entities corresponding to a first element type (e.g., corresponding to the first nodes 235 of the graph triples 230), a list of entity types corresponding to the list of entities, a list of relationships corresponding to the list of entities, or any combination thereof. For example, the response 255 may indicate an entity associated with or indicated by a first node 235 (e.g., which may be common to multiple graph triples 230), a list of entities that are associated with or indicated by respective second nodes 240 that are related to the first node 235 through corresponding relationships (e.g., indicated by the respective edges 245 connecting the second nodes 240 to the first node 235).

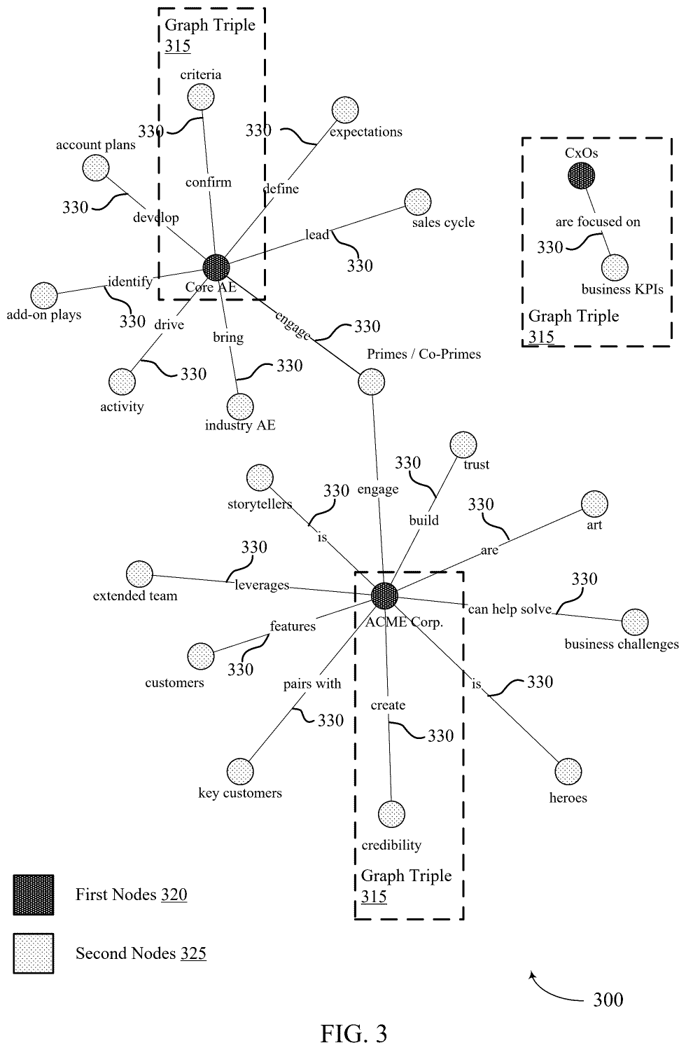

FIG. 3 shows an example of a knowledge graph 300 that supports large language model-based knowledge graphs in accordance with examples as disclosed herein. The knowledge graph 300 may be an unconstrained knowledge graph that may indicate multiple first nodes 320, second nodes 325, and edges 330. The first nodes 320 may be referred to as “central” nodes and the second nodes 325 may be referred to as “branch” nodes. As depicted, the knowledge graph 300 may include sets of graph triples 315 that each include a first node 320, a second node 325, and an edge 330. Though some graph triples 315 are highlighted, each set of a first node 320 and second node connected by a corresponding edge may be considered a graph triple 315.

For example, the depicted graph triple 315 includes a first node 320 designated “ACME Corp.,” a second node 325 designated “credibility,” and an edge 330 designated as “create.” In this example, the various elements of the graph triples 315 are different semantic elements extracted from an ingested document. For example, the first nodes 320 indicate a subject identified in the document, the second nodes 325 indicate objects identified in the document that are related to the subject, and the edges 330 indicate a relationship (e.g., a predicate) associated with the subject and the object. In some examples, such graph triples 315 may be referred to as semantic triples, subject-predicate-object triples, or subject-relationship-object triples. For example, the graph triple 315 indicates a subject of “ACME Corp.,” a predicate of “create,” and an object of “credibility.” As such, the graph triple 315 indicates, through semantic expressions and relationships corresponding to the first node 320, the second node 325, and the edge 330, the idea that ACME Corp. creates credibility. In this way, the knowledge graph may express ideas from the ingested documents in an information-dense manner while still allowing easy access and organization so that an LLM may utilize the knowledge graph to generate responses to LLM queries.

In some examples, the knowledge graph 300 may include a second node 325 that may be associated with or connected to multiple first nodes 320 via multiple edges 330 and may be referred to as a “bridge” node. For example, the second node 325 indicating “Primes/Co-Primes” may be associated with both the first node 320 indicating “Core AE” and the first node 320 indicating “ACME Corp.,” through respective edges indicating “engage.” Thus, based on the knowledge graph 300, it may be determined that the document indicates that ACME Corp. engages primes/co-primes as well as that the Core AE engages primes/co-primes.

Further, the knowledge graph 300 may include multiple graphs or webs that may not be connected. For example, the first node 320 indicating CxOs (e.g., chief executive officers (CEOs), chief financial officers (CFOs), chief technology officers (CTOs), etc.), the edge indicating “are focused on,” and the second node 325 indicating “business KPIs” form a graph triple 315 that is not connected to other graph triples 315 of the knowledge graph 300.

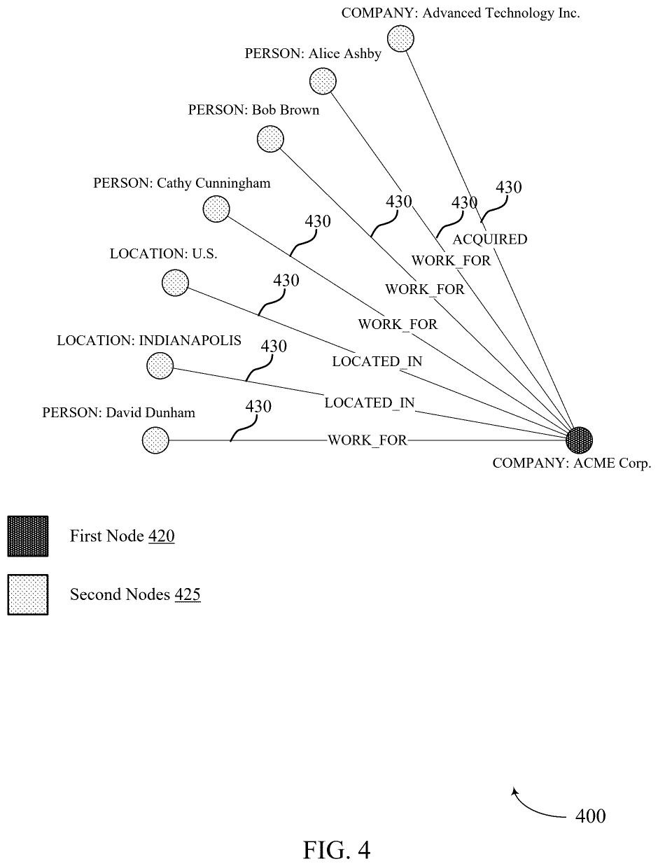

FIG. 4 shows an example of a knowledge graph 400 that supports large language model-based knowledge graphs in accordance with examples as disclosed herein.

The knowledge graph 400 may be an example of a knowledge graph that includes constrained graph triples. For example, as in other examples, each graph triple may include a first node 420, a second node 325, and an edge 430. However, in the knowledge graph 400, each graph triple may indicate information that is constrained (e.g., based on client input or other parameters). For example, a client may indicate in a request that the LLM is to provide information associated with ACME Corp., such as employees of ACME Corp., what companies has ACME Corp. acquired, and where ACME Corp. is located. As such, the resulting knowledge graph 400 may include or indicate ACME Corp. in the first node 420 (e.g., as all of the requested information was constrained to be about ACME Corp.) as a requested or constrained subject. The other information displayed corresponds to the requested relationships, categories, or other information about ACME Corp., and the second nodes 425 may indicate the results or other information that falls within the requested relationships, categories, or other information.

For example, the various edges 430 indicate relationships of employment (“WORK_FOR”), location (“LOCATED_IN”), and acquisitions (“ACQUIRED”) associated with a company (“COMPANY: ACME Corp.”). The various second nodes 420 indicate results or other information that is associated with the indicated or constrained relationships. For example, the knowledge graph 400 indicates that Alice Ashby, Bob Brown, Cathy Cunningham, and David Dunham all work for ACME Corp. (e.g., as expressed by the second nodes of “PERSON:Alice Ashby”, “PERSON:Bob Brown”, “PERSON:Cathy Cunningham”, and “PERSON:David Dunham”) that ACME Corp. is located in Indianapolis and in the United States (e.g., as expressed by the second nodes of “LOCATION:Indianapolis” and “LOCATION:U.S.”) and that ACME Corp. has acquired Advanced Technology Inc. (e.g., as expressed by “COMPANY:Advanced Technology, Inc.”).

In some examples, the output of an LLM utilizing the knowledge graph to produce a response may include a list of the various entities (e.g., those indicated by the second nodes 425) and a corresponding list of relationships (e.g., those indicated by the edges 430). Such lists may be presented to the user as a response (or included within a response) to an LLM query.

In this way, entities (e.g., person, company, or job title), relationships (e.g., works for, is located in, acquired) may be specified and the resulting knowledge graph 400 may be constrained accordingly. By including such a structure of the knowledge graph 400, downstream ingestion, analysis, or other use of the knowledge graph 400 (e.g., creating records or executing APIs) may be simplified.

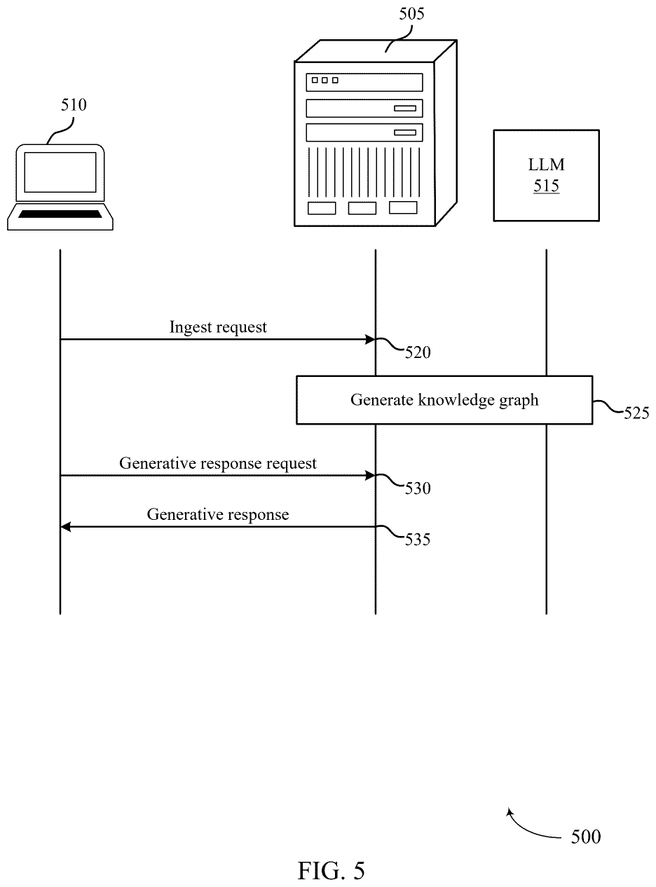

FIG. 5 shows an example of a process flow 500 that supports large language model-based knowledge graphs in accordance with examples as disclosed herein.

The process flow 500 may implement various aspects of the present disclosure described herein. The elements described in the process flow 500 (e.g., server 505, client 510, and LLM 515) may be examples of similarly named elements described herein.

In the following description of the process flow 500, the operations between the various entities or elements may be performed in different orders or at different times. Some operations may also be left out of the process flow 500, or other operations may be added. Although the various entities or elements are shown performing the operations of the process flow 500, some aspects of some operations may also be performed by other entities or elements of the process flow 500 or by entities or elements that are not depicted in the process flow, or any combination thereof.

At 520, the server 505 may receive a first request to ingest a document. In some examples, the first request to ingest the document may include an indication of the first element type, the second element type, and the third element type.

At 525, the server 505 may generate, using a large language model (LLM 515) and based on the first request and the document, a knowledge graph that may include a plurality of graph triples, each graph triple that may include a first node, a second node, and an edge connecting the first node and the second node and each first node corresponds to a first element type comprised in the document and each second node corresponds to a second element type comprised in the document, and wherein each edge corresponds to a third element type comprised in the document. In some examples, the first element type may include a semantic subject, the second element type may include a semantic object, and the third element type may include a semantic predicate. In some examples, the first element type is associated with one or more first entities, the second element type is associated with one or more second entities, the third element type may indicate relationships between entities, or any combination thereof. In some examples, respective first nodes of at least two graph triples are a same first node. In some examples, respective second nodes of at least two graph triples are a same second node. In some examples, generating the knowledge graph includes transmitting, to the LLM 515 and based on the first request to ingest the document, a request to generate the knowledge graph. In some examples, generating the knowledge graph includes receiving, from the LLM 515 and based on the request to generate the knowledge graph, an indication of the knowledge graph. In some examples, generating the knowledge graph includes identifying, via the LLM 515, one or more instances of the first element type, the second element type, the third element type, or any combination thereof, to generate the plurality of graph triples. In some examples, generating the knowledge graph includes identifying, via the LLM 515, one or more instances of a fourth element type that is different than the first element type, the second element type, and the third element type.

At 530, the server 505 may receive a second request to generate a generative response with the LLM 515.

At 535, the server 505 may present a response to the second request, the response generated by the LLM 515 based on the knowledge graph. In some examples, the response may include a list of entities corresponding to the first element type, a list of entity types corresponding to the list of entities, a list of relationships corresponding to the list of entities, or any combination thereof. In some examples, the response may include a plurality of sentences, each respective sentence of the plurality of sentences corresponding to a respective graph triple of the knowledge graph.

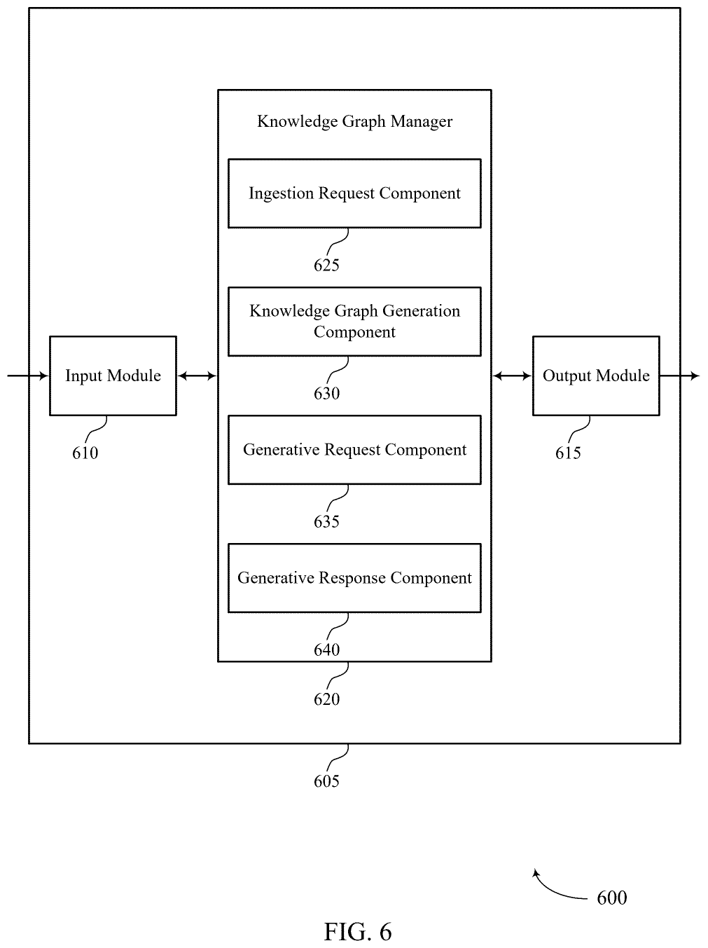

FIG. 6 shows a block diagram 600 of a device 605 that supports large language model-based knowledge graphs in accordance with examples as disclosed herein. The device 605 may include an input module 610, an output module 615, and a knowledge graph manager 620. The device 605, or one or more components of the device 605 (e.g., the input module 610, the output module 615, the knowledge graph manager 620), may include at least one processor, which may be coupled with at least one memory, to support the described techniques. Each of these components may be in communication with one another (e.g., via one or more buses).

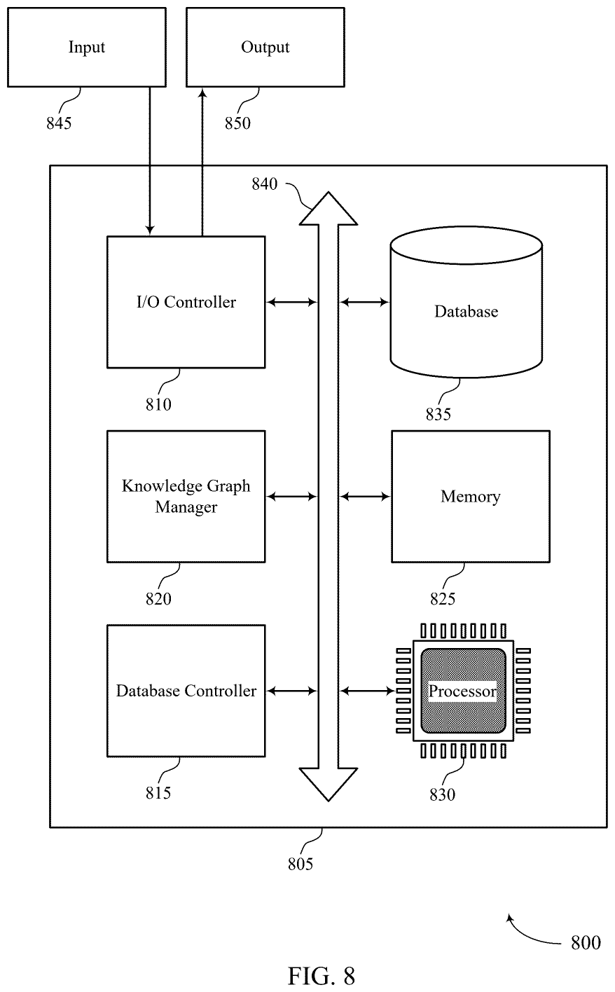

The input module 610 may manage input signals for the device 605. For example, the input module 610 may identify input signals based on an interaction with a modem, a keyboard, a mouse, a touchscreen, or a similar device. These input signals may be associated with user input or processing at other components or devices. In some cases, the input module 610 may utilize an operating system such as iOS®, ANDROID®, MS-DOS®, MS-WINDOWS®, OS/2®, UNIX®, LINUX®, or another known operating system to handle input signals. The input module 610 may send aspects of these input signals to other components of the device 605 for processing. For example, the input module 610 may transmit input signals to the knowledge graph manager 620 to support large language model-based knowledge graphs. In some cases, the input module 610 may be a component of an input/output (I/O) controller 810 as described with reference to FIG. 8.

The output module 615 may manage output signals for the device 605. For example, the output module 615 may receive signals from other components of the device 605, such as the knowledge graph manager 620, and may transmit these signals to other components or devices. In some examples, the output module 615 may transmit output signals for display in a user interface, for storage in a database or data store, for further processing at a server or server cluster, or for any other processes at any number of devices or systems. In some cases, the output module 615 may be a component of an I/O controller 810 as described with reference to FIG. 8.

For example, the knowledge graph manager 620 may include an ingestion request component 625, a knowledge graph generation component 630, a generative request component 635, a generative response component 640, or any combination thereof. In some examples, the knowledge graph manager 620, or various components thereof, may be configured to perform various operations (e.g., receiving, monitoring, transmitting) using or otherwise in cooperation with the input module 610, the output module 615, or both. For example, the knowledge graph manager 620 may receive information from the input module 610, send information to the output module 615, or be integrated in combination with the input module 610, the output module 615, or both to receive information, transmit information, or perform various other operations as described herein.

The knowledge graph manager 620 may support data processing in accordance with examples as disclosed herein. The ingestion request component 625 may be configured to support receiving a first request to ingest a document. The knowledge graph generation component 630 may be configured to support generating, using a large language model (LLM) and based on the first request and the document, a knowledge graph including a set of multiple graph triples, each graph triple including a first node, a second node, and an edge connecting the first node and the second node, where each first node corresponds to a first element type included in the document, where each second node corresponds to a second element type included in the document, and where each edge corresponds to a third element type included in the document. The generative request component 635 may be configured to support receiving a second request to generate a generative response with the LLM. The generative response component 640 may be configured to support presenting a response to the second request, the response generated by the LLM based on the knowledge graph.

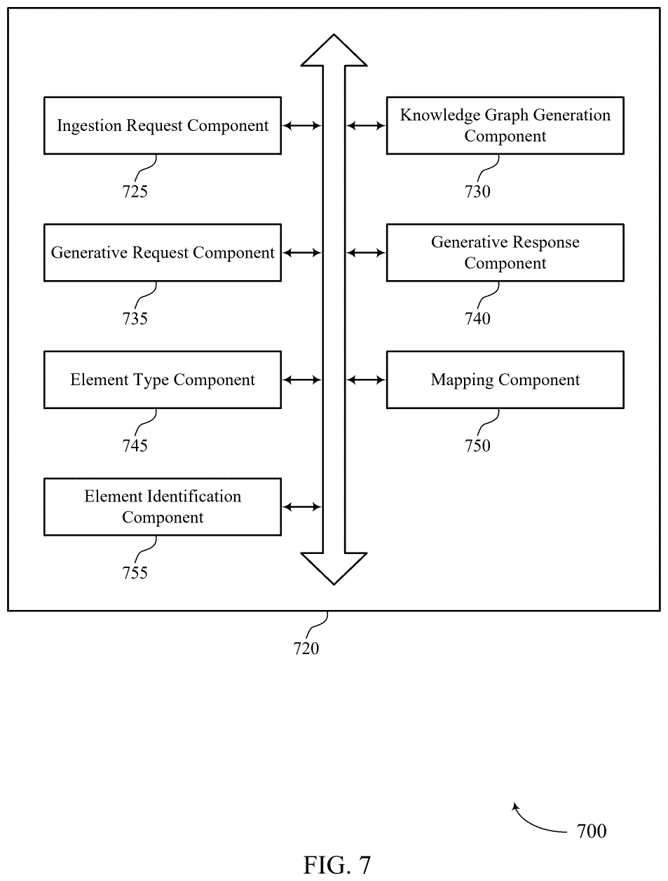

FIG. 7 shows a block diagram 700 of a knowledge graph manager 720 that supports large language model-based knowledge graphs in accordance with examples as disclosed herein. The knowledge graph manager 720 may be an example of aspects of a knowledge graph manager or a knowledge graph manager 620, or both, as described herein. The knowledge graph manager 720, or various components thereof, may be an example of means for performing various aspects of large language model-based knowledge graphs as described herein. For example, the knowledge graph manager 720 may include an ingestion request component 725, a knowledge graph generation component 730, a generative request component 735, a generative response component 740, an element type component 745, a mapping component 750, an element identification component 755, or any combination thereof. Each of these components, or components of subcomponents thereof (e.g., one or more processors, one or more memories), may communicate, directly or indirectly, with one another (e.g., via one or more buses).

The knowledge graph manager 720 may support data processing in accordance with examples as disclosed herein. The ingestion request component 725 may be configured to support receiving a first request to ingest a document. The knowledge graph generation component 730 may be configured to support generating, using a large language model (LLM) and based on the first request and the document, a knowledge graph including a set of multiple graph triples, each graph triple including a first node, a second node, and an edge connecting the first node and the second node, where each first node corresponds to a first element type included in the document, where each second node corresponds to a second element type included in the document, and where each edge corresponds to a third element type included in the document. The generative request component 735 may be configured to support receiving a second request to generate a generative response with the LLM. The generative response component 740 may be configured to support presenting a response to the second request, the response generated by the LLM based on the knowledge graph.

In some examples, the first element type includes a semantic subject, the second element type includes a semantic object, and the third element type includes a semantic predicate.

In some examples, the first request to ingest the document includes an indication of the first element type, the second element type, and the third element type.

In some examples, the first element type is associated with one or more first entities, the second element type is associated with one or more second entities, the third element type indicates relationships between entities, or any combination thereof.

In some examples, the response includes a list of entities corresponding to the first element type, a list of entity types corresponding to the list of entities, a list of relationships corresponding to the list of entities, or any combination thereof.

In some examples, the response includes a set of multiple sentences, each respective sentence of the set of multiple sentences corresponding to a respective graph triple of the knowledge graph.

In some examples, respective first nodes of at least two graph triples are a same first node.

In some examples, respective second nodes of at least two graph triples are a same second node.

In some examples, to support generating the knowledge graph, the generative response component 740 may be configured to support transmitting, to the LLM and based on the first request to ingest the document, a request to generate the knowledge graph. In some examples, to support generating the knowledge graph, the generative response component 740 may be configured to support receiving, from the LLM and based on the request to generate the knowledge graph, an indication of the knowledge graph.

In some examples, to support generating the knowledge graph, the element identification component 755 may be configured to support identifying, via the LLM, one or more instances of the first element type, the second element type, the third element type, or any combination thereof, to generate the set of multiple graph triples.

In some examples, to support generating the knowledge graph, the element identification component 755 may be configured to support identifying, via the LLM, one or more instances of a fourth element type that is different than the first element type, the second element type, and the third element type.

FIG. 8 shows a diagram of a system 800 including a device 805 that supports large language model-based knowledge graphs in accordance with examples as disclosed herein. The device 805 may be an example of or include components of a device 605 as described herein. The device 805 may include components for bi-directional data communications including components for transmitting and receiving communications, such as a knowledge graph manager 820, an I/O controller, such as an I/O controller 810, a database controller 815, at least one memory 825, at least one processor 830, and a database 835. These components may be in electronic communication or otherwise coupled (e.g., operatively, communicatively, functionally, electronically, electrically) via one or more buses (e.g., a bus 840).

The I/O controller 810 may manage input signals 845 and output signals 850 for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. In other cases, the I/O controller 810 may represent or interact with a modem, a keyboard, a mouse, a touchscreen, or a similar device. In some cases, the I/O controller 810 may be implemented as part of a processor 830. In some examples, a user may interact with the device 805 via the I/O controller 810 or via hardware components controlled by the I/O controller 810.

The database controller 815 may manage data storage and processing in a database 835. In some cases, a user may interact with the database controller 815. In other cases, the database controller 815 may operate automatically without user interaction. The database 835 may be an example of a single database, a distributed database, multiple distributed databases, a data store, a data lake, or an emergency backup database.

Memory 825 may include random-access memory (RAM) and read-only memory (ROM). The memory 825 may store computer-readable, computer-executable software including instructions that, when executed, cause at least one processor 830 to perform various functions described herein. In some cases, the memory 825 may contain, among other things, a basic I/O system (BIOS) which may control basic hardware or software operation such as the interaction with peripheral components or devices. The memory 825 may be an example of a single memory or multiple memories. For example, the device 805 may include one or more memories 825.

The processor 830 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 830 may be configured to operate a memory array using a memory controller. In other cases, a memory controller may be integrated into the processor 830. The processor 830 may be configured to execute computer-readable instructions stored in at least one memory 825 to perform various functions (e.g., functions or tasks supporting large language model-based knowledge graphs). The processor 830 may be an example of a single processor or multiple processors. For example, the device 805 may include one or more processors 830.

The knowledge graph manager 820 may support data processing in accordance with examples as disclosed herein. For example, the knowledge graph manager 820 may be configured to support receiving a first request to ingest a document. The knowledge graph manager 820 may be configured to support generating, using a large language model (LLM) and based on the first request and the document, a knowledge graph including a set of multiple graph triples, each graph triple including a first node, a second node, and an edge connecting the first node and the second node, where each first node corresponds to a first element type included in the document, where each second node corresponds to a second element type included in the document, and where each edge corresponds to a third element type included in the document. The knowledge graph manager 820 may be configured to support receiving a second request to generate a generative response with the LLM. The knowledge graph manager 820 may be configured to support presenting a response to the second request, the response generated by the LLM based on the knowledge graph.

By including or configuring the knowledge graph manager 820 in accordance with examples as described herein, the device 805 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

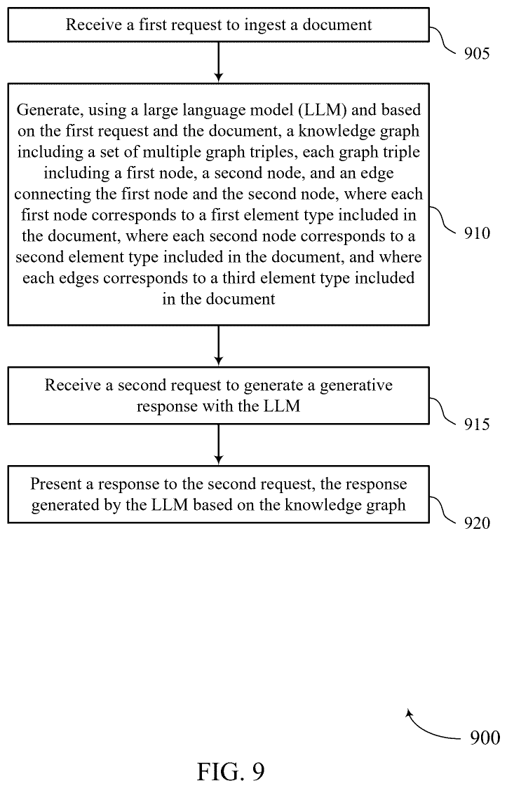

FIG. 9 shows a flowchart illustrating a method 900 that supports large language model-based knowledge graphs in accordance with examples as disclosed herein. The operations of the method 900 may be implemented by an application server or its components as described herein. For example, the operations of the method 900 may be performed by an application server as described with reference to FIGS. 1 through 8. In some examples, an application server may execute a set of instructions to control the functional elements of the application server to perform the described functions. Additionally, or alternatively, the application server may perform aspects of the described functions using special-purpose hardware.

At 905, the method may include receiving a first request to ingest a document. The operations of 905 may be performed in accordance with examples as disclosed herein. In some examples, aspects of the operations of 905 may be performed by an ingestion request component 725 as described with reference to FIG. 7.

At 910, the method may include generating, using a large language model (LLM) and based on the first request and the document, a knowledge graph including a set of multiple graph triples, each graph triple including a first node, a second node, and an edge connecting the first node and the second node, where each first node corresponds to a first element type included in the document, where each second node corresponds to a second element type included in the document, and where each edge corresponds to a third element type included in the document. The operations of 910 may be performed in accordance with examples as disclosed herein. In some examples, aspects of the operations of 910 may be performed by a knowledge graph generation component 730 as described with reference to FIG. 7.

At 915, the method may include receiving a second request to generate a generative response with the LLM. The operations of 915 may be performed in accordance with examples as disclosed herein. In some examples, aspects of the operations of 915 may be performed by a generative request component 735 as described with reference to FIG. 7.

At 920, the method may include presenting a response to the second request, the response generated by the LLM based on the knowledge graph. The operations of 920 may be performed in accordance with examples as disclosed herein. In some examples, aspects of the operations of 920 may be performed by a generative response component 740 as described with reference to FIG. 7.

A method for data processing by an application server is described. The method may include receiving a first request to ingest a document, generating, using a large language model (LLM) and based on the first request and the document, a knowledge graph including a set of multiple graph triples, each graph triple including a first node, a second node, and an edge connecting the first node and the second node, where each first node corresponds to a first element type included in the document, where each second node corresponds to a second element type included in the document, and where each edge corresponds to a third element type included in the document, receiving a second request to generate a generative response with the LLM, and presenting a response to the second request, the response generated by the LLM based on the knowledge graph.

An application server for data processing is described. The application server may include one or more memories storing processor executable code, and one or more processors coupled with the one or more memories. The one or more processors may individually or collectively be operable to execute the code to cause the application server to receive a first request to ingest a document, generate, using a large language model (LLM) and based on the first request and the document, a knowledge graph including a set of multiple graph triples, each graph triple including a first node, a second node, and an edge connecting the first node and the second node, where each first node corresponds to a first element type included in the document, where each second node corresponds to a second element type included in the document, and where each edge corresponds to a third element type included in the document, receive a second request to generate a generative response with the LLM, and present a response to the second request, the response generated by the LLM based on the knowledge graph.

Another application server for data processing is described. The application server may include means for receiving a first request to ingest a document, means for generating, using a large language model (LLM) and based on the first request and the document, a knowledge graph including a set of multiple graph triples, each graph triple including a first node, a second node, and an edge connecting the first node and the second node, where each first node corresponds to a first element type included in the document, where each second node corresponds to a second element type included in the document, and where each edge corresponds to a third element type included in the document, means for receiving a second request to generate a generative response with the LLM, and means for presenting a response to the second request, the response generated by the LLM based on the knowledge graph.

A non-transitory computer-readable medium storing code for data processing is described. The code may include instructions executable by one or more processors to receive a first request to ingest a document, generate, using a large language model (LLM) and based on the first request and the document, a knowledge graph including a set of multiple graph triples, each graph triple including a first node, a second node, and an edge connecting the first node and the second node, where each first node corresponds to a first element type included in the document, where each second node corresponds to a second element type included in the document, and where each edge corresponds to a third element type included in the document, receive a second request to generate a generative response with the LLM, and present a response to the second request, the response generated by the LLM based on the knowledge graph.

In some examples of the method, application servers, and non-transitory computer-readable medium described herein, the first element type includes a semantic subject, the second element type includes a semantic object, and the third element type includes a semantic predicate.

In some examples of the method, application servers, and non-transitory computer-readable medium described herein, the first request to ingest the document includes an indication of the first element type, the second element type, and the third element type.

In some examples of the method, application servers, and non-transitory computer-readable medium described herein, the first element type may be associated with one or more first entities, the second element type may be associated with one or more second entities, the third element type indicates relationships between entities, or any combination thereof.

In some examples of the method, application servers, and non-transitory computer-readable medium described herein, the response includes a list of entities corresponding to the first element type, a list of entity types corresponding to the list of entities, a list of relationships corresponding to the list of entities, or any combination thereof.

In some examples of the method, application servers, and non-transitory computer-readable medium described herein, the response includes a set of multiple sentences, each respective sentence of the set of multiple sentences corresponding to a respective graph triple of the knowledge graph.

In some examples of the method, application servers, and non-transitory computer-readable medium described herein, respective first nodes of at least two graph triples may be a same first node.

In some examples of the method, application servers, and non-transitory computer-readable medium described herein, respective second nodes of at least two graph triples may be a same second node.

In some examples of the method, application servers, and non-transitory computer-readable medium described herein, generating the knowledge graph may include operations, features, means, or instructions for transmitting, to the LLM and based on the first request to ingest the document, a request to generate the knowledge graph and receiving, from the LLM and based on the request to generate the knowledge graph, an indication of the knowledge graph.

In some examples of the method, application servers, and non-transitory computer-readable medium described herein, generating the knowledge graph may include operations, features, means, or instructions for identifying, via the LLM, one or more instances of the first element type, the second element type, the third element type, or any combination thereof, to generate the set of multiple graph triples.

In some examples of the method, application servers, and non-transitory computer-readable medium described herein, generating the knowledge graph may include operations, features, means, or instructions for identifying, via the LLM, one or more instances of a fourth element type that may be different than the first element type, the second element type, and the third element type.

The following provides an overview of aspects of the present disclosure:

Aspect 1: A method for data processing at an application server, comprising: receiving a first request to ingest a document; generating, using a large language model (LLM) and based at least in part on the first request and the document, a knowledge graph comprising a plurality of graph triples, each graph triple comprising a first node, a second node, and an edge connecting the first node and the second node, wherein each first node corresponds to a first element type comprised in the document, wherein each second node corresponds to a second element type comprised in the document, and wherein each edge corresponds to a third element type comprised in the document; receiving a second request to generate a generative response with the LLM; and presenting a response to the second request, the response generated by the LLM based at least in part on the knowledge graph.

Aspect 2: The method of aspect 1, wherein the first element type comprises a semantic subject, the second element type comprises a semantic object, and the third element type comprises a semantic predicate.

Aspect 3: The method of any of aspects 1 through 2, wherein the first request to ingest the document comprises an indication of the first element type, the second element type, and the third element type.

Aspect 4: The method of aspect 3, wherein the first element type is associated with one or more first entities, the second element type is associated with one or more second entities, the third element type indicates relationships between entities, or any combination thereof.

Aspect 5: The method of any of aspects 3 through 4, wherein the response comprises a list of entities corresponding to the first element type, a list of entity types corresponding to the list of entities, a list of relationships corresponding to the list of entities, or any combination thereof.

Aspect 6: The method of any of aspects 1 through 5, wherein the response comprises a plurality of sentences, each respective sentence of the plurality of sentences corresponding to a respective graph triple of the knowledge graph.

Aspect 7: The method of any of aspects 1 through 6, wherein respective first nodes of at least two graph triples are a same first node.

Aspect 8: The method of any of aspects 1 through 7, wherein respective second nodes of at least two graph triples are a same second node.

Aspect 9: The method of any of aspects 1 through 8, wherein generating the knowledge graph comprises: transmitting, to the LLM and based at least in part on the first request to ingest the document, a request to generate the knowledge graph; and receiving, from the LLM and based at least in part on the request to generate the knowledge graph, an indication of the knowledge graph.

Aspect 10: The method of any of aspects 1 through 9, wherein generating the knowledge graph comprises: identifying, via the LLM, one or more instances of the first element type, the second element type, the third element type, or any combination thereof, to generate the plurality of graph triples.

Aspect 11: The method of any of aspects 1 through 10, wherein generating the knowledge graph comprises: identifying, via the LLM, one or more instances of a fourth element type that is different than the first element type, the second element type, and the third element type.

Aspect 12: An application server for data processing, comprising one or more memories storing processor-executable code, and one or more processors coupled with the one or more memories and individually or collectively operable to execute the code to cause the application server to perform a method of any of aspects 1 through 11.

Aspect 13: An application server for data processing, comprising at least one means for performing a method of any of aspects 1 through 11.

Aspect 14: A non-transitory computer-readable medium storing code for data processing, the code comprising instructions executable by one or more processors to perform a method of any of aspects 1 through 11.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data processing at an application server, comprising:
receiving a first request to ingest a document;
generating, using a large language model (LLM) and based at least in part on the first request and the document, a knowledge graph comprising a plurality of graph triples, each graph triple comprising a first node, a second node, and an edge connecting the first node and the second node, wherein each first node corresponds to a first element type comprised in the document, wherein each second node corresponds to a second element type comprised in the document, and wherein each edge corresponds to a third element type comprised in the document;
receiving a second request to generate a generative response with the LLM; and
presenting a response to the second request, the response generated by the LLM based at least in part on the knowledge graph.

2. The method of claim 1, wherein the first element type comprises a semantic subject, the second element type comprises a semantic object, and the third element type comprises a semantic predicate.

3. The method of claim 1, wherein the first request to ingest the document comprises an indication of the first element type, the second element type, and the third element type.

4. The method of claim 3, wherein the first element type is associated with one or more first entities, the second element type is associated with one or more second entities, the third element type indicates relationships between entities, or any combination thereof.

5. The method of claim 3, wherein the response comprises a list of entities corresponding to the first element type, a list of entity types corresponding to the list of entities, a list of relationships corresponding to the list of entities, or any combination thereof.

6. The method of claim 1, wherein the response comprises a plurality of sentences, each respective sentence of the plurality of sentences corresponding to a respective graph triple of the knowledge graph.

7. The method of claim 1, wherein respective first nodes of at least two graph triples are a same first node.

8. The method of claim 1, wherein respective second nodes of at least two graph triples are a same second node.

9. The method of claim 1, wherein generating the knowledge graph comprises:
transmitting, to the LLM and based at least in part on the first request to ingest the document, a request to generate the knowledge graph; and
receiving, from the LLM and based at least in part on the request to generate the knowledge graph, an indication of the knowledge graph.

10. The method of claim 1, wherein generating the knowledge graph comprises:
identifying, via the LLM, one or more instances of the first element type, the second element type, the third element type, or any combination thereof, to generate the plurality of graph triples.

11. The method of claim 1, wherein generating the knowledge graph comprises:
identifying, via the LLM, one or more instances of a fourth element type that is different than the first element type, the second element type, and the third element type.

12. An application server for data processing, comprising:
one or more memories storing processor-executable code; and
one or more processors coupled with the one or more memories and individually or collectively operable to execute the code to cause the application server to:
receive a first request to ingest a document;
generate, using a large language model (LLM) and based at least in part on the first request and the document, a knowledge graph comprising a plurality of graph triples, each graph triple comprising a first node, a second node, and an edge connecting the first node and the second node, wherein each first node corresponds to a first element type comprised in the document, wherein each second node corresponds to a second element type comprised in the document, and wherein each edge corresponds to a third element type comprised in the document;
receive a second request to generate a generative response with the LLM; and
present a response to the second request, the response generated by the LLM based at least in part on the knowledge graph.

13. The application server of claim 12, wherein the first element type comprises a semantic subject, the second element type comprises a semantic object, and the third element type comprises a semantic predicate.

14. The application server of claim 12, wherein the first request to ingest the document comprises an indication of the first element type, the second element type, and the third element type.

15. The application server of claim 14, wherein the first element type is associated with one or more first entities, the second element type is associated with one or more second entities, the third element type indicates relationships between entities, or any combination thereof.

16. The application server of claim 14, wherein the response comprises a list of entities corresponding to the first element type, a list of entity types corresponding to the list of entities, a list of relationships corresponding to the list of entities, or any combination thereof.

17. The application server of claim 12, wherein the response comprises a plurality of sentences, each respective sentence of the plurality of sentences corresponding to a respective graph triple of the knowledge graph.

18. The application server of claim 12, wherein respective first nodes of at least two graph triples are a same first node.

19. The application server of claim 12, wherein respective second nodes of at least two graph triples are a same second node.

20. A non-transitory computer-readable medium storing code for data processing, the code comprising instructions executable by one or more processors to:
receive a first request to ingest a document;
generate, using a large language model (LLM) and based at least in part on the first request and the document, a knowledge graph comprising a plurality of graph triples, each graph triple comprising a first node, a second node, and an edge connecting the first node and the second node, wherein each first node corresponds to a first element type comprised in the document, wherein each second node corresponds to a second element type comprised in the document, and wherein each edge corresponds to a third element type comprised in the document;
receive a second request to generate a generative response with the LLM; and
present a response to the second request, the response generated by the LLM based at least in part on the knowledge graph.
